(19) United States
(12) Patent Application Publication
(10) Pub. No.: US 2013/0262437 A1
(43) Pub. Date: Oct. 3, 2013

(54) Energy-Efficient Query Optimization

(71) Applicant: Sameer Abhinkar, Portland, OR (US)

(72) Inventor: Sameer Abhinkar, Portland, OR (US)

(21) Appl. No.: 13/992,817

(22) PCT Filed: Dec. 30, 2011
(86) PCT No.: PCT/US11/68018

§ 371 Date: Jun. 10, 2013

(51) Int. Cl. G06F 17/30

(52) U.S. Cl. CPC G06F 17/30477
USPC 707/718

(57) ABSTRACT

A query optimizer may determine the time sensitivity of a database query using the query semantics information. The query optimizer may determine a query execution plan based on the time sensitivity of the database query. The query execution plan may also be based on performance characteristics of database servers.

### BACKGROUND

This relates generally to database technology. A database query is a structured statement that is sent to a database in order to get information back from the database. Database queries may be written in a query language such as Structured Query Language (SQL). A database server may be a server hosting a database management system, and may receive database queries from external computer systems.

### BRIEF DESCRIPTION OF THE DRAWINGS

FIG. 1 is a depiction of a system in accordance with one embodiment of the present invention;

FIG. 2 is a flow chart in accordance with one embodiment of the present invention;

FIGS. 3A-3B are examples in accordance with one embodiment of the present invention;

FIG. 4 is a schematic depiction of an apparatus in accordance with one embodiment of the present invention.

### DETAILED DESCRIPTION

In accordance with some embodiments, database queries may be executed based on query semantics information. As used herein, “query semantics information” or “semantic information” generally refer to data associated with a database query which may describe or relate to time characteristics of the database query. In one or more embodiments, a query optimizer may determine the time sensitivity of a database query using the query semantics information. The query optimizer may assign the query to be executed by a particular database server at a specified time based on the time sensitivity. Such an assignment may be based on executing the query with as little energy or performance cost as feasible. Accordingly, embodiments may enable database queries to be executed in an energy-efficient manner.

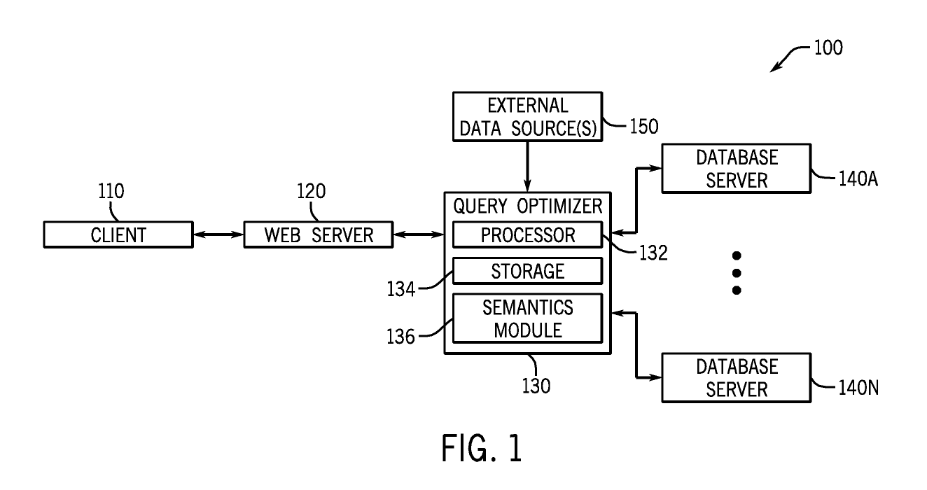

FIG. 1 shows a system 100 including a client computer 110, a web server 120, a query optimizer server 130, external data source(s) 150, and any number of database servers 140 (e.g., nodes 140A-140N). The components of system 100 may be connected by a computer network (e.g., a wired network, a wireless network, Internet, etc.). The client computer 110 may be any computing device such as a personal computer (PC), a desktop computer, a laptop, a tablet, a mainframe, a server, a telephone, a kiosk, a cable box, a personal digital assistant (PDA), a mobile phone, a smart phone, etc.

In one or more embodiments, the web server 120 may include functionality to deliver content that can be accessed through a computer network (e.g., the Internet, an intranet, etc.). For example, the web server 120 may be configured to deliver web pages in response to requests from the client computer 110. The web server 120 may also execute server-side scripting (e.g., Active Server Pages (ASP) scripts, PHP scripts, etc.). The web server 120 may be implemented in hardware, software, and/or firmware.

Each database server 140 may be a computer server hosting a database management system, and may be configured to receive and process database queries. In one or more embodiments, each database server 140 may have unique performance characteristics. As used herein, “performance characteristics” may refer to any information related to the current and future power and/or performance states of a database server 140. For example, a performance characteristic may include the current operating mode of each server (e.g., server A is in sleep mode, server B is in low power or reduced performance mode, server C is in normal operating mode, server D is completely powered down, etc.). Another example of a performance characteristic may include a planned maintenance schedule for the database server 140A (e.g., shut down at 2 A.M., turn on at 6 A.M., etc.). Yet another example of a performance characteristic may include a current work load of each server (e.g., number of transactions, bandwidth utilization, etc.). Note that these examples are merely illustrative, and are not intended to limit embodiments of the invention.

In one or more embodiments, the query optimizer 130 (also referred to as a “query optimizer server”) includes functionality to determine an efficient way to execute a query. For example, the query optimizer 130 may determine a query plan for executing a database query received from the web server 120.

As shown, the query optimizer 130 may be implemented as a server including a processor 132, storage 134, and a semantics module 136. The processor 132 may be any integrated circuit, processor, microprocessor, core of a microprocessor, etc. The storage 134 may include any non-persistent memory device (e.g., random access memory (RAM), cache memory, etc.) and/or persistent memory device (e.g., hard disk, flash memory, optical drive such as a compact disk drive or digital video disk (DVD) drive, etc. Alternatively, the query optimizer 130 may be implemented in software and/or firmware. Note that, although not shown for the sake of clarity, the client computer 110, the web server 120 and the database servers 140 may each also include a processor 132 and storage 134.

In one or more embodiments, the semantics module 136 may include functionality to determine the time sensitivity of a database query based on query semantics information. The time sensitivity may be expressed as a quantitative measure (e.g., hours, minutes, etc.), a qualitative measure (e.g., urgent, high, medium, low), or by any other means.

In one or more embodiments, the query semantics information may be any information related to or indicative of any time requirements of a user or entity associated with a database query. For example, semantic information may include a calendar or schedule, travel plans, documents, emails, financial records, notes, personal files, metadata, social network links, blog posts, tweets, photographs, videos, subscriptions, data feeds, text messages, geographical coordinates, purchases, etc.

The semantics module 136 may obtain the query semantics information from any location or source. For example, the query semantics information may be obtained from external data source(s) 150, including communication providers, websites, online social networks, network drives, data repositories, information clearinghouses, vendors, search engines, mapping tools, encyclopedias, email logs, banks, credit bureaus, and/or any other information source. In another example, the query semantics information may also be obtained from user profiles, files, logs, or metadata stored on client computer 110 or query optimizer 130. In yet another example, the query semantics information may also be obtained from data stored on a personal device (e.g., a cellular phone, a handheld computer, etc.).

In one or more embodiments, the semantics module 136 may include functionality to obtain performance characteristics of the database servers 140. For example, the semantics module 136 may receive the performance characteristics via a network message or notification from database servers 140A.

In one or more embodiments, the semantics module 136 may also include functionality to determine a query execution plan for a database query based on the time sensitivity of the query and/or performance characteristics of the database servers 140. The execution plan may specify a particular database server 140 and date/time to execute the query. For example, the execution plan may specify that an urgent query is to be executed immediately on the first available database server 140. The execution plan may also specify particular steps to be performed within the database in executing a query (e.g., index scans, sequential scans, sort-merge joins, hash joins, nested loop joins, etc.).

In another example, the execution plan may specify that a non-urgent query is to be executed at 3 A.M. on a database server 140 having a low cost (e.g., cheaper pricing, less energy consumption, etc.) for executing queries during early morning hours.

In yet another example, assume that a non-urgent query is suitable to be partially executed over multiple time periods. In such a situation, the execution plan may specify that the query is to be executed in portions by multiple database servers 140 during short intervals of available processing capacity on each database server 140. The semantics module 136 may then combine the results from each partial execution to produce the final results of the query.

In one or more embodiments, the semantics module 136 may include functionality to send a database query to a database server 140 for execution. Further, in one or more embodiments, the semantics module 136 may also include functionality to store a database query for later execution. For example, assume that the execution plan specifies that a query is to be executed in one hour on database server 140A. In this situation, the semantics module 136 may store the database query on the query optimizer 130. Alternatively, the semantics module 136 may store the database query on database server 140A, or any other suitable location.

In one or more embodiments, the semantics module 136 may include functionality to send, along with the database query, information related to the time urgency of the database query. For example, the semantics module 136 may embed additional information (e.g., semantic information, an execution plan, etc.) in the query, and then send the query to a database server 140 for execution. In another example, the semantics module 136 may send the additional information out-of-band to the query (i.e., using a separate communication path than the query) to the database server 140. The database server 140 may then use the additional information in executing the query.

The semantics module 136 may be implemented in hardware, software, and/or firmware. In firmware and software embodiments it may be implemented by computer executed instructions stored in a non-transitory computer readable medium, such as an optical, semiconductor, or magnetic storage device.

Note that the system 100 is merely illustrative, and is not intended to limit embodiments of the invention. Other embodiments are contemplated. For example, the client computer 110 may access query optimizer 130 or a database server 140 without using a web server 120. In another example, the functionality of the web server 120 may be implemented in the query optimizer 130. In yet another example, the functionality of the query optimizer 130 may be implemented in one or more database servers 140.

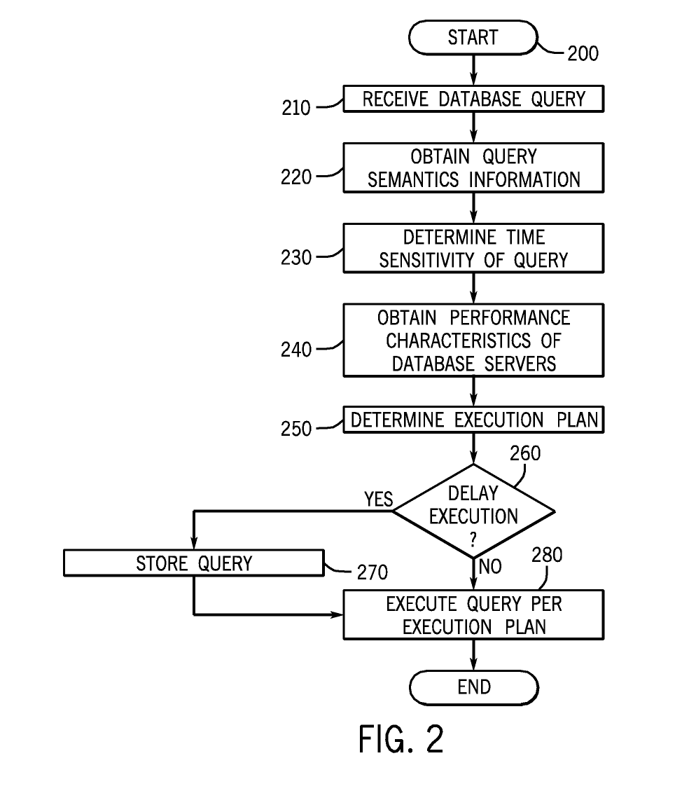

FIG. 2 shows a sequence 200 for executing a query in accordance with one or more embodiments. The sequence 200 may be implemented in hardware, software, and/or firmware. In firmware and software embodiments it may be implemented by computer executed instructions stored in a non-transitory computer readable medium, such as an optical, semiconductor, or magnetic storage device. In one embodiment, the sequence 200 may be part of the semantics module 136 shown in FIG. 1. In another embodiment, the sequence 200 may be implemented by any other element shown in FIG. 1.

At step 210, a database query may be received. In one or more embodiments, the query may be generated in response to a direct user command. For example, referring to FIG. 1, query optimizer 130 may receive a query specified by a user interacting with the client computer 110. In another embodiment, the query may be generated automatically. For example, query optimizer 130 may receive a query generated automatically by a software agent on the web server 120.

At step 220, query semantics information (i.e., semantic information related to the query received at step 210) may be obtained. For example, referring to FIG. 1, query optimizer 130 may obtain query semantics information from the client computer 110 and/or the external data source(s) 150.

At step 230, a time sensitivity of the query may be determined based on the query semantics information (obtained at step 220). For example, referring to FIG. 1, query optimizer 130 may determine the time sensitivity of the received query based on semantic information for the query.

At step 240, performance characteristics of available database servers may be obtained. For example, referring to FIG. 1, query optimizer 130 may receive information related to the current and planned states of the database servers 140A-140N. Such information may include, e.g., a power mode, a performance mode, a sleep state, a planned maintenance schedule, a current work load, a bandwidth utilization, a number of pending transactions, etc.

At step 250, an execution plan for the query may be determined. For example, referring to FIG. 1, query optimizer 130 may determine an execution plan for the query (received at step 210). In one or more embodiments, the execution plan may specify a particular database server 140 and a date/time to execute the query. The execution plan may also specify the manner of executing the query (e.g., in a single transaction, in multiple parallel transactions, in multiple serial transactions, etc. In addition, the execution plan may also specify particular steps to be performed within the database in executing the query.

At step 260, a determination may be made about whether the execution plan requires the execution of the query to be delayed. If not, then the sequence 200 continues at step 280 (described below). However, if it is determined at step 260 that the execution of the query is to be delayed, then at step 270, the query may be stored for later execution. For example, the query may be stored on the query optimizer 130, on a database server 140, etc. After step 270, at the specified time for executing the query, the stored query may be sent to the database server 140. At step 280, the query may be executed according to the execution plan. After step 280, the sequence 200 ends.

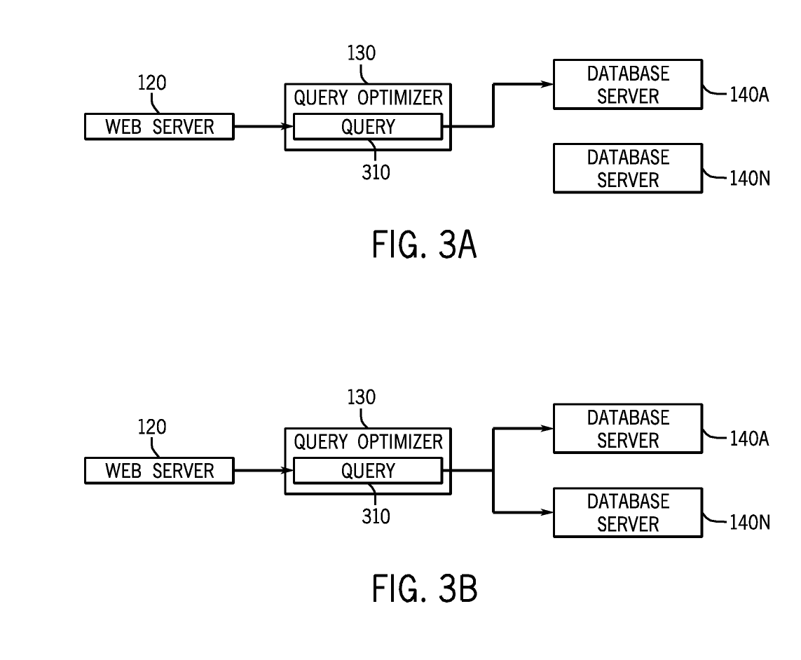

Referring now to FIG. 3A, an example is depicted in accordance with one or more embodiments. In this example, query optimizer 130 receives a query 310, which may be automatically generated by a software agent (not shown) on web server 120. Assume that the software agent has issued the query 310 in response to determining that a user (e.g., an end user of client computer 110) may be travelling to city A soon. Assume further that the query is to identify hotel, dining, and transportation facilities which may be used by the user while staying in city A.

In response to receiving the query 310, the query optimizer 130 (e.g., using semantics module 130 shown in FIG. 1) may obtain semantic information related to the query 310. For example, the query optimizer 130 may interact with the user's calendar to determine that the user will be travelling to city A in ten days, and will stay there for three days. Thus, the query optimizer 130 may determine that the time sensitivity for the query 310 is ten days (i.e., the period of time before the user will require the results of the query).

In this example, the query optimizer 130 obtains performance characteristics of database servers 140A and 140N. Assume that the performance characteristics indicate that, in ten days, the operating mode of database server 140A will enable it to execute the query 310 using less energy than database server 140N.

Based on the time sensitivity and the performance characteristics, the query optimizer 130 may determine an execution plan specifying that the query 310 is to be stored for ten days before being executed by database server 140A. Accordingly, as shown, the query 310 is stored in the query optimizer 130, and is then executed by database server 140A.

Referring now to FIG. 3B, another example is depicted in accordance with one or more embodiments. Assume the same circumstances described above with reference to FIG. 3A. However, in this example, assume that the query optimizer 130 obtains additional semantic information by interacting with a restaurant review website. Specifically, assume that the additional semantic information indicates that restaurants in city A are typically booked nine days in advance. Thus, in this situation, the query optimizer 130 may determine that the time sensitivity for the query 310 is one day (i.e., the time remaining before restaurant reservations become unavailable to the user).

Assume that the performance characteristics indicate that, for the next two days, database servers 140A and 140N are reserved for processing high-priority transactions, and will only be available at various time slots of brief duration. Assume further that none of the available time slots is individually sufficient for executing query 310. Finally, assume that query 310 may be executed in one day by being partially executed in potions during the available time slots of database servers 140A and 140N.

Accordingly, the query optimizer 130 may determine an execution plan specifying that the query 310 is to be stored until in the query optimizer 130, and is to be executed during the available time slots of database servers 140A and 140N. Note that the examples shown in FIGS. 3A-3B are provided for the sake of illustration, and are not intended to limit embodiments of the invention.

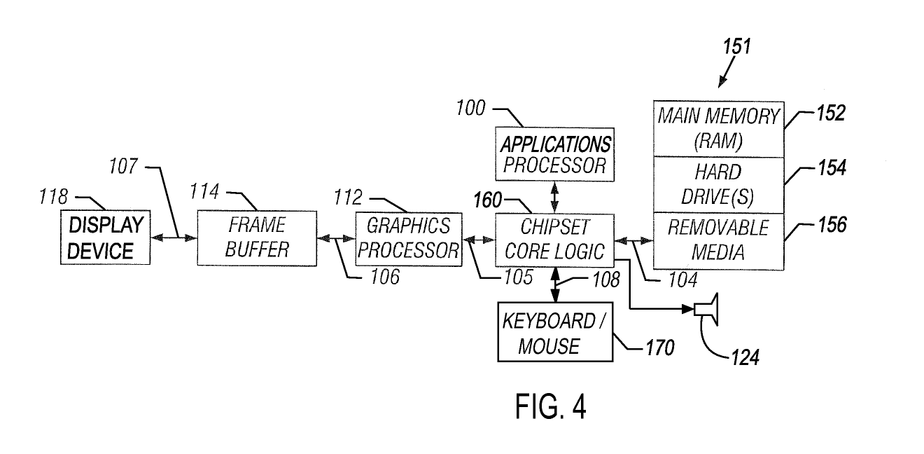

FIG. 4 depicts a computer system 151, which may be the computers shown in FIG. 1 (e.g., client computer 110, web server 120, query optimizer 130, and/or database servers 140). The computer system 151 may include a hard drive 154 and a removable medium 156, coupled by a bus 104 to a chipset core logic 160. A keyboard and mouse 170, or other conventional components, may be coupled to the chipset core logic via bus 108. The core logic may couple to the graphics processor 112 via a bus 105, and the applications processor 100 in one embodiment. The graphics processor 112 may also be coupled by a bus 106 to a frame buffer 114. The frame buffer 114 may be coupled by a bus 107 to a display device 118, such as a liquid crystal display (LCD) screen. In one embodiment, a graphics processor 112 may be a multi-threaded, multi-core parallel processor using single instruction multiple data (SIMD) architecture.

The chipset logic 160 may include a non-volatile memory port to couple the main memory 152. Speakers 124 may also be coupled through logic 110.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. For example, it is contemplated that the functionality described above with reference to any particular component or module may be included in any other component or module (or any combinations thereof). It is intended that the appended claims cover all such modifications and variations as fall within the true spirit and scope of this present invention.

What is claimed is:

1. A method comprising:
receiving a database query from a client computer; and
selecting, based on a time sensitivity of the database query, one of a plurality of database servers to execute the database query.

2. The method of claim 1 wherein selecting one of the plurality of database servers to execute the database query is also based on a performance characteristic of each of the plurality of database servers.

3. The method of claim 1 further comprising storing the database query for later execution.

4. The method of claim 3 wherein storing the database query comprises storing the database query on a query optimizer server.

5. The method of claim 4 further comprising, after storing the database query on the query optimizer server, sending the database query to the selected one of the plurality of database servers.

6. The method of claim 3 wherein storing the database query comprises storing the database query on the selected one of the plurality of database servers.

7. The method of claim 1 further comprising determining the time sensitivity of the query based on query semantics information.

8. The method of claim 7 further comprising obtaining the query semantics information from at least one data source external to the plurality of database servers.

9. The method of claim 7 further comprising obtaining the query semantics information from user information.

10. The method of claim 1 further comprising obtaining a performance characteristic of each of the plurality of database servers

11. The method of claim 1 further comprising determining an execution plan for executing the database query.

12. The method of claim 1 further comprising executing the database query on the selected one of the plurality of database servers.

13. A non-transitory computer readable medium storing instructions to cause the computer to:
receive a database query;
determine a time sensitivity of the database query; and
select, based on the time sensitivity of the database query, one of a plurality of database servers to execute the database query.

14. The medium of claim 13 wherein selecting one of the plurality of database servers to execute the database query is also based on a performance characteristic of each of the plurality of database servers.

15. The medium of claim 13 further storing instructions to store the database query for later execution.

16. The medium of claim 15 wherein storing the database query for later execution comprises storing the database query on a query optimizer server.

17. The medium of claim 13 further storing instructions to determine the time sensitivity of the query based on query semantics information.

18. The medium of claim 17 further storing instructions to obtain the query semantics information from an external data source.

19. The medium of claim 17 further storing instructions to obtain the query semantics information from a user profile.

20. The medium of claim 13 further storing instructions to determine an execution plan for executing the database query.

21. An apparatus comprising:
a hardware processor; and
a semantics module executed by the hardware processor, the semantics module to:
receive a database query from a client computer,
determine a time sensitivity of the database query,
obtain performance characteristics for a plurality of database servers, and
select, based on the time sensitivity and the performance characteristics, at least one of the plurality of database servers to execute the database query.

22. The apparatus of claim 21 wherein the semantics module is to determine time sensitivity of the database query using query semantics information.

23. The apparatus of claim 23 wherein the semantics module is also to obtain the query semantics information from a website.

24. The apparatus of claim 23 wherein the semantics module is also to obtain the query semantics information from a personal computing device.

25. The apparatus of claim 21 wherein obtaining the performance characteristics comprises obtaining an operating mode for each of the plurality of database servers.

26. The apparatus of claim 21 wherein obtaining the performance characteristics comprises obtaining an planned maintenance schedule for each of the plurality of database servers.

27. The apparatus of claim 21 wherein obtaining the performance characteristics comprises obtaining a current work load for each of the plurality of database servers.

28. The apparatus of claim 21 wherein obtaining the performance characteristics comprises obtaining a bandwidth utilization for each of the plurality of database servers.

29. The apparatus of claim 21 wherein obtaining the performance characteristics comprises obtaining a number of pending transactions for each of the plurality of database servers.

30. The apparatus of claim 21 wherein the semantics module is also to store the query for later execution.
